(19) United States
(12) Patent Application Publication
(10) Pub. No.: US 2008/0296906 A1
(43) Pub. Date: Dec. 4, 2008

(54) POWER GENERATION SYSTEM USING WIND TURBINES

(75) Inventors: JAMES SHIHFU SHIAO, STOW, OH (US); ALBERT SHIHYUNG SHIAO, STOW, OH (US)

Correspondence Address: Emerson, Thomson & Bennett, LLC, 777 W. Market Street, Akron, OH, 44303, US

(73) Assignee: DAW SHIEN SCIENTIFIC RESEARCH AND DEVELOPMENT, INC., Stow, OH (US)

(21) Appl. No.: 12/195,623

(22) Filed: Aug. 21, 2008

Related U.S. Application Data
(63) Continuation-in-part of application No. 12/035,851, filed on Feb. 22, 2008.
Application No. 12/035,851 is a continuation-in-part of application No. 11/472,517, filed on Jun. 12, 2006.

(51) Int. Cl. F03D 9/00

(52) U.S. Cl. 290/55

(57) ABSTRACT

The wind turbines system can extract the dynamic energy from ambient sources and generate power with high efficiency. The less-fluctuated slower-speed turbines have a main pump, a fluctuation-pressure stabilizer, a power generation water-turbines, and a high ratio gear reducer mounted together on the ground to increase its generator's speed and produce power at about 50% efficiency. A fluctuation-pressure stabilizer stabilizes the fluctuations of the hydraulic flow and regularizes its output to water-turbines in a single steady state, continuously. A high ratio gear reducer (1:1,000=1:10×10×10 in three stages) increases its generator's speed and meet its power generation requirements. The larger surface area of light-weight nylon fabric single-surfaced blade layer with strong angle strut support structure more efficiently convert wind energy into high-power DC electricity through the contacting/grinding reactions of a light-weight generator. Owing to these conservative processes, metallurgical material costs, installation capital, and maintenance costs are reduced.

This patent application is a continuation-in-part of U.S. Ser. No. 12/035,851 entitled HIGH EFFICIENT HEAT ENGINE PROCESS USING EITHER WATER OR LIQUEFIED GASES FOR ITS WORKING FLUID AT LOW TEMPERATURES, filed on Feb. 22, 2008, and is also a continuation-in-part of U.S. Ser. No. 11/472,517 entitled DUAL-PLASMA-FUSION JET THRUSTERS USING DC TURBO-CONTACTING GENERATOR AS ITS ELECTRICAL POWER SOURCE, filed on Jun. 12, 2006, the content of which are hereby incorporated by reference.

### I. FIELD OF THE INVENTION

The present invention relates generally to generating power in steady state at ambient temperatures by using the new stronger but lighter-weight wind turbines' blade system reacting with air as a working fluid via a steady state power generation process, and more particularly to a method of using slower-speed, balanced wind turbines' blades attached to a main pump, a fluctuation-pressure stabilizer, a power generation water-turbines, and a high-ratio gear reducer to increase the high-power DC contacting/grinding generator's speed in a steady way and meet its power generation requirements.

### II. BACKGROUND OF THE INVENTION

In recent years, the conventional wind turbine engines have demanded higher efficiency, which would have light-weight nylon fabric single-surfaced blades of strong angle strut support structure behind for their higher power production requirements and need more advanced technology.

The conventional wind turbine engine only has low efficiency, and the conventional wind turbines' blades are required to be redesigned to have light-weight nylon fabric single-surfaced blades of stronger angle strut support frame structure behind with more reaction surface area, and run their light-weight generators in a steady state with more efficiency.

The conventional wind turbine engine and blades are also considered to have similar process elements of a power generator, but they are called by different names. The conventional wind turbine engine runs its processes in a low efficiency through those elements of the conventional heavier blade with reversed shape and unstable power generation system. Therefore, the conventional wind power engine process can only generate small portion amount from its available power.

If a wind turbine blade operated with the leading edge reversed such that it becomes the new single stream-line surfaced blade, and putting the pointed tail edge to be its front leading edge of the strong support structure, then its efficiency will be even higher than the conventional wind turbine blade. If the conventional wind turbines' blades had a larger surface area, they would generate more power than they did.

In the inventive process, the slower-speed turbines can take more wind pressure difference, extract more air/blade speed difference, and generate more power. Conventional blades need to be re-designed with more stream-line-like, more stably rotating at a slower speed with less ball-bearing friction wornness. These slower-speed less-fluctuating turbines are connected to a main pump, a fluctuation-pressure stabilizer, a power generation water-turbines, and a high ratio gear reducer (1:1,000=1:10×10×10 in three stages) to increase its light-weight high-power DC contacting/grinding generator's rotating speed in a single steady state and meet its power generation requirements, continuously.

These slow-speed, single-surfaced nylon layer with strong support structure behind, and less-fluctuated running turbines connected with a main pump, a fluctuation-pressure stabilizer, a power generation water-turbines, and a high ratio gear reducer may extract fluctuated force from fast air stream to generate more useful and stable power, continuously. They minimize the disadvantages of the conventional running turbines in a faster but even less stable way and minimize their ball-bearing wornness.

ΣP.ΔA_{Large}=P.[large blade area×many numbers of blades]=F_{Large}

If the blade's pitch angle is 45° facing to the attacking wind:
F.(Δt)=Δ(mv)=(m.Δv); For steady state flow and movement, and;
F.Δt=Δ(mv)=(mΔv)=Σρ.v.ΔA.Δt.Δv=(∫ρₐᵢᵣ.vₐᵢᵣ.2πr.dr.Δt(vₐᵢᵣ−v_{blade})sin 45°)
F.Δt=∫ρₐᵢᵣ.vₐᵢᵣ.2πr.dr.Δt(vₐᵢᵣ−2πr(rpm/60 sec))sin 45°; where v_{blade}=2πr.(rpm/60 sec)
F=(Σρ.v.ΔA).Δv=∫ρ.v.2πr.dr.(vₐᵢᵣ−2πr.(rpm/60 sec)).sin 45°

Torque Γ=ΣΔF.r.sin θ=ΣΔF.r.sin 90°=ΣΔF.r

If the blade's pitch angle is 45° facing to the attacking wind:
Torque Γ=ΣΔF.r=∫₀^{R}(ρₐᵢᵣ.vₐᵢᵣ.2πr.dr.(vₐᵢᵣ−2πr.(rpm/60 sec)).(sin 45°)).r
Power produced=Σ(ΔForce F).v_{blade}; where v_{blade}=(2πr.(rpm/60 sec)
Power produced=∫₀^{R}(ρₐᵢᵣ.vₐᵢᵣ.2πr.dr.(vₐᵢᵣ−2πr.(rpm/60 sec))sin 45°).2πr.(rpm/60 sec)
Power produced=ρₐᵢᵣ.vₐᵢᵣ.π².R³ [( 4/3)vₐᵢᵣ−2πR.(rpm/60 sec)].(rpm/60 sec).sin 45°;

Find maximum power of desired: d(power)/dR=0; d²(power)/d²R<0.

For d(power)/dR=0; vₐᵢᵣ=(2π.R [rpm/60 sec])=v_{blade's tip}; v_{blade's tip}=vₐᵢᵣ;
Substitute vₐᵢᵣ=(2π.R [rpm/60 sec])=v_{blade's tip}; back into above equations, we get
Maximum power produced=(⅔)ρₐᵢᵣ.vₐᵢᵣ.π³.R⁴ [rpm/60 sec]².(sin 45°);
Maximum power produced=11.2 ton-m/sec=110,000 Newton-m/sec; ρₐᵢᵣ=0.0012; vₐᵢᵣ=10 m/sec; R=5 m; where v_{blade's tip} is the same as the wind speed vₐᵢᵣ; ρ is the density;
v is the speed; v_{blade's tip} is the blade tip's speed; R is the blade's radius; P is pressure; A is the area; Γ is the Torque.

Another advantage of these light-weight nylon fabric made single-surfaced blades with strong angle strut support frame structure behind makes these less-fluctuated slow-turbines run through the fast air stream and generated maximum power more stably and more efficiently with a pressure stabilizer mounted on the ground, and they are much easier and much cheaper to be built and maintained on the ground.

A wind power device is another example of a device, which absorbs energy at ambient temperature and perpetuates generating power from the solar energy's thermal convection current for lasting.

### III. SUMMARY OF THE INVENTION

The present invention utilizes less-fluctuated wind turbine blades and a new light-weight generator together, from which this fluctuating air stream energy can be extracted out into the much more stable electricity through a main pump, a fluctuation-pressure stabilizer, a power generation water-turbines, a high-ratio gear reducer, and the new Shiao's generator (an advanced light-weight model to the Van de Graff generator). This process, which uses air as its working fluid will not discharge cooling water out, or generate thermal pollutions, or radioactive pollution (which might be discharged from conventional power plants) into the global environment.

An advantage of the present invention is that its weight is much lighter and it is more stream-lined and efficient than the conventional wind turbines. It just uses wind fluctuating current's energy built from the solar energy, to push the larger air/blades surface-area to generate more electricity in a single steady state.

Another advantage of the present invention is the flexibility of the wind turbines' system process. It may use air (or oxygen and nitrogen) as its working fluid, transfer energy, and extract work from the air/blade reactions, in which the blade can have single-surfaced blade layer with strong angle strut supporting structure from behind. More air/blade reaction surface area, less-fluctuated and slower-rotation-speed, and more stable power-generation states with its higher pressure difference (force) generated are these better designs.

If the blade's pitch angle is 45° facing to the attacking wind: Minimum wind speed for blades starting to rotate: Torque Γ=∫r.dF=∫r.d(m_{blades}.a_{tangential})

and if the blades covered the surface area of 1.414 times of the whole circle:
where a_{tangential} is tangential acceleration; α is tangential angular acceleration; ρ_{blade} is the density of the blade.
If R=5 meters; ρ_{blade}=0.94; ρₐᵢᵣ=0.0012; α the angular acceleration≈0.05 rad/sec²; blade's thickness=0.001 meter; blade's surface covered area factor ≈1.414:
Torque Γ_{blade}=ΣΔF.r=∫₀^{R}(ρ_{blade}.(blade's thickness).(factor 1.414).2πr.dr.(r.α).r
Torque Γ_{blade}=ΣΔF.r=∫₀^{5m}(0.94(0.001 m).(area factor 1.414).2πr.dr.(r.α).r
Torque Γ_{blade}=ΣΔF_{blade}.r=1.3α=0.065; where α≈0.05 rad/sec²
   For the wind power and torque:
Torque Γₐᵢᵣ=ΣΔFₐᵢᵣ.r=∫₀^{R}(ρₐᵢᵣ.vₐᵢᵣ.2πr.dr.(vₐᵢᵣ−2πr.(rpm/60 sec)).(sin 45°)).r
Torque Γₐᵢᵣ=ρₐᵢᵣ.vₐᵢᵣ.π.R³ [(⅔)vₐᵢᵣ−πR.(rpm/60 sec)].sin 45°;
   While starting rotating: v_{blade}=2πr.(rpm/60 sec)≈0; substitute this stationary blade speed, 0, back into the above equation, we get
Torque Γₐᵢᵣ=(⅔)ρₐᵢᵣ.(vₐᵢᵣ)².π.R³.sin 45°=(⅔).0.0012.(vₐᵢᵣ)².π.(5 m)³.sin 45°;
Torque Γₐᵢᵣ=0.22195(vₐᵢᵣ)²>Torque Γ_{blade}=0.065_{blade}
Torque Γ=0.22195(vₐᵢᵣ)²>0.065_{blade}; solved for (vₐᵢᵣ)>0.54 m/sec>1.9 km/hr
   The minimum wind speed for blades (R=5 m) starting to rotate at: [vₐᵢᵣ>1.9 km/hr]

The present invention is a cyclic process, whose effect can generate power from the ambient temperature of solar-thermal-current fluctuating energy and also can use its stabilization electricity to cool down the surrounding temperature lower than room temperature (as by transferring heat energy into work from solar energy of using air (or oxygen and nitrogen) as its working fluid). That is noted in U.S. Ser. No. 12/035,851 filed on Feb. 22, 2008. It is meant that the surrounding dissipates heat by contacting with the colder working fluid to generate steady power and have the surrounding temperature cooled down to lower than its room temperature (i.e. a new air conditioner runs through taking the solar energy, instead of taking the power from wall).

This new high efficient wind turbines power generation process can use air for its working fluid by using (1) less-fluctuated slower-speed turbines attached with a main pump, a fluctuation-pressure stabilizer, a power generation water-turbines, and a high ratio gear reducer to increase its light-weight generator's speed in a much more steady way and meet its power generation requirements, continuously, and (2) using the new Shiao's light-weight generator to generate electricity through contacting/grinding reactions into high-power DC electricity.

This new invention provides improvements over the conventional wind turbines' engine processes. And these new larger-surface area blades can generate more power directly into high-power DC electricity through contacting/grinding reactions without using the conventional electromagnetic generator and power transformer. The conventional heavy electromagnetic generators may need more transforming stages to transfer their system power from the low voltage to the high voltage, which may cut down their efficiencies.

This new process can have the wind turbines power generation close to 50% efficiency, and use its electricity to run the air conditioner and refrigerator with higher efficiency, that may only need smaller heat transfer surface area.

This new air/wind turbines power generation process can produce power under temperatures lower than the ambient temperature. This useful wind turbines' power generation process can use air for its working fluid at low temperatures without damaging the environment (no chemical refrigerants leaking, no cooling water discharge, no thermal pollution, and no radioactive or hazardous wastes).

### IV. BRIEF DESCRIPTION OF THE DRAWINGS

The invention may take physical forms in certain parts and arrangement of parts, embodiments of which will be described in detail in this specification and illustrated in the accompanying drawings which form a part hereof and wherein:

FIG. 1 is a schematic diagram of the conventional wind turbines' engine and its blade's cross section;

FIG. 2 is a schematic diagram of the inventive down-wind wind turbines power generation process and the less-fluctuated slower-speed turbines with a pumping pressure stabilizer and a high-ratio gear reducer attached to the new light-weight generator, they are mounted on the ground;

FIG. 3 is a schematic diagram of the conventional blade's heavy and solid cross section and the new light-weight nylon fabric single-surfaced blades in the front of strong angle strut support structure's cross section;

FIG. 4 is a schematic diagram of the new automatic hydraulic safety device to adjust the blade's pitch by its uneven strong wind pressure generated at the blade's rear parts, automatically;

FIG. 5 is a schematic diagram of the new pumping stabilizer. It stabilizes the pump's pressure and regularizes its output to water-turbines in a single steady state, continuously; and,

FIG. 6 is a schematic diagram of the new Shiao's light-weight generator mounted on the ground, which generates the high-power DC electricity through contacting/grinding reactions.

### V. DETAILED DESCRIPTION

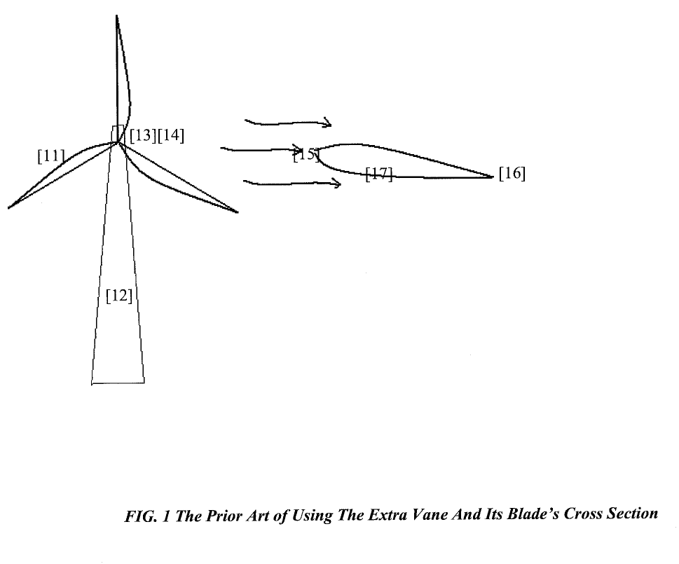

With reference now to FIG. 1, the conventional wind turbines engine process includes three propeller (narrow and slender) blades [11], a pole [12], a heavy electromagnetic generator [13] on the top of the high pole [12], and a vane [14]. The cross section [17] of the conventional blade is shown in FIG. 1: the leading edge [15] of both upper and lower sides is bigger, which may generate higher pressure in front of the edge [15], blocking and reducing the in-coming wind stream. Therefore, that may slow down the incoming wind speed and reduce the air force acting on rotation, and the pointed tail [16] does not aid this problem much.

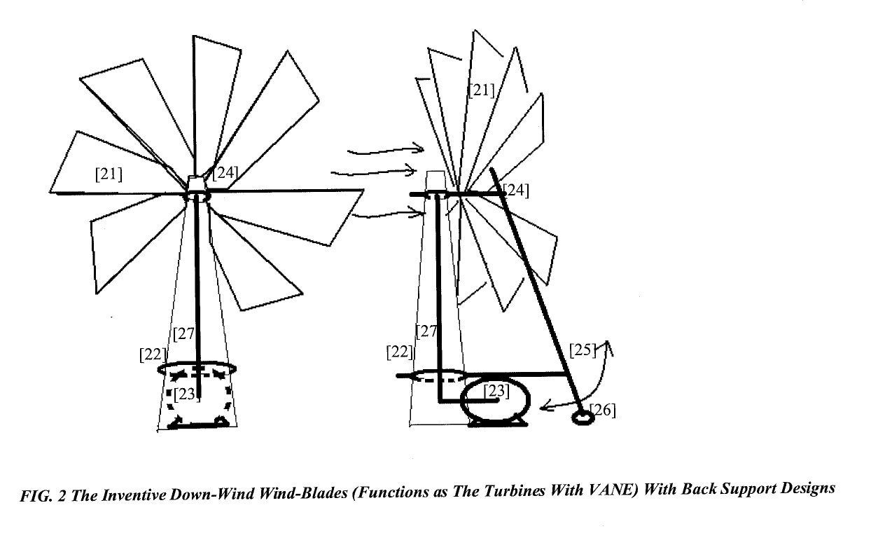

With reference now to FIG. 2, the present new wind turbines power generation processes include multiple large surface area blades [21], central lower pole (mounting member) [22], the stable power generation system [23] mounted on the ground, down-wind wind blades structure (also acting like a vane [24] with a rotational shaft), strong back-supported structure [25], and rolling wheels [26]. The rotation shafts [27] connect the above wind turbines [21] to the ground mounted main pump and other power generation systems [23]. This embodiment of two-phase (or three-phase in rainy and snowing days) turbines [21] uses many large surface area blades [21]: ΣP.ΔA_{Large}=P.[large blade area×many numbers of blades]=F_{Large}, which enables more ambient air fluctuating energy to be extracted out into the steady electricity through this light-weight high-power DC contacting generator system [23], the effect of which is just like grinding two different material-made cylinders/rollers generating high-power DC electricity. In one embodiment, the turbine has eight to sixteen blades, but it is to be understood that any number of blades could be used, as long as chosen by using sound engineering force and power judgments.

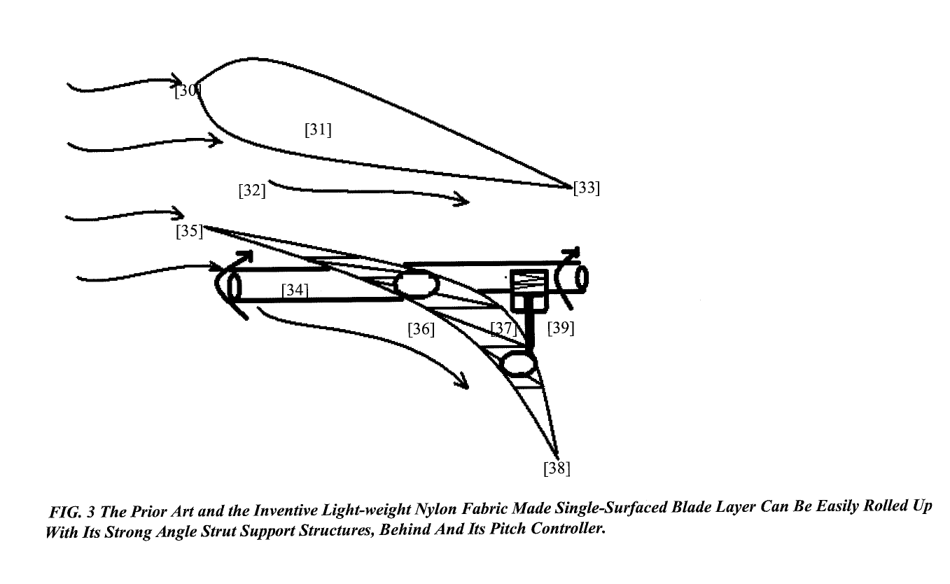

With reference now to FIG. 3, the conventional propeller-like blade's cross section has a bigger leading edge [30] of both upper and lower sides, heavy solid stretched body [31] for avoiding heavy blades from break, and pointed tail-end [33]. While wind crosses/attacks the leading edge [30], it is going to generate a higher pressure and more drag force in front of blades. The present invention includes numerous larger reaction surface-area blades mounted on the rotating shaft [34]. Each blade has a sharp stream-lined leading edge [35], nylon fabric made single-surfaced blade [36] with strong angle strut support structure body frame [37], and a sharp stream-lined tailing edge [38], which are much lighter than the conventional solid propeller-like blades. It is also easier to control its pitch and its rotation speed through its automatic hydraulic pitch controller [39].

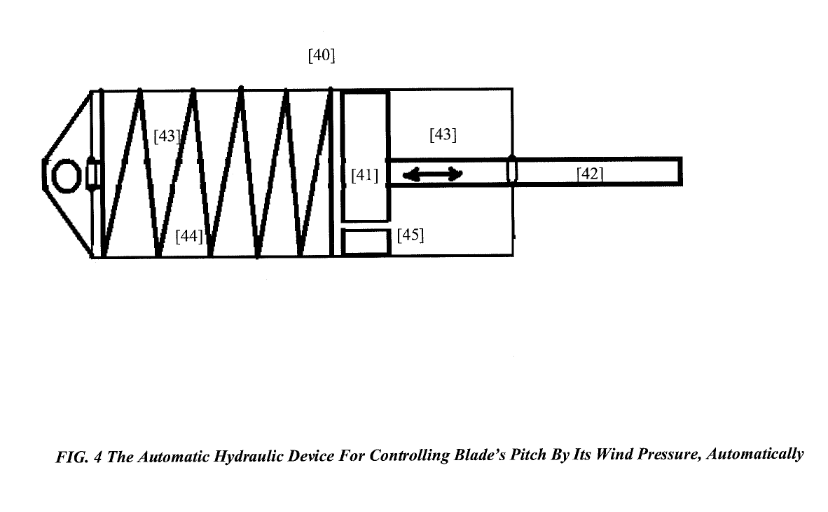

With reference now to FIG. 4, the present new design includes an automatic hydraulic pitch controller [40], which has a piston [41] to balance the strong uneven force of changing pitch, sliding shaft [42] to adjust the distance of the pitched blade, hydraulic oil container [43] to reduce the damping effects by its oil's hydraulic pressure, strong spring [44] is forced to change by the blade's pressure, and oil flows in/out [45] to reduce and balance the blade's pitch damping movements. This auto-hydraulic pitch controller [40] controls the pitch of the blade in order to control and stabilize the blade speed, blade pressurized rotational force, and the amount of power generation. It is also acted as a safety device to protect the system from constant storm attacks. It automatically adjusts the pitch of blade by its uneven strong wind pressure generated at the blade's rear parts if the wind speed exceeds approximately over 50 miles/hr=80 km/hr. However, it is to be understood that any wind speed could be used, as long as chosen by using sound engineering elasticity and force judgments.

In the event of an emergency, the single-surfaced blade layer, made of nylon fabric, can be easily rolled up to close to the central shaft region to avoid hurricanes or for other safety reasons.

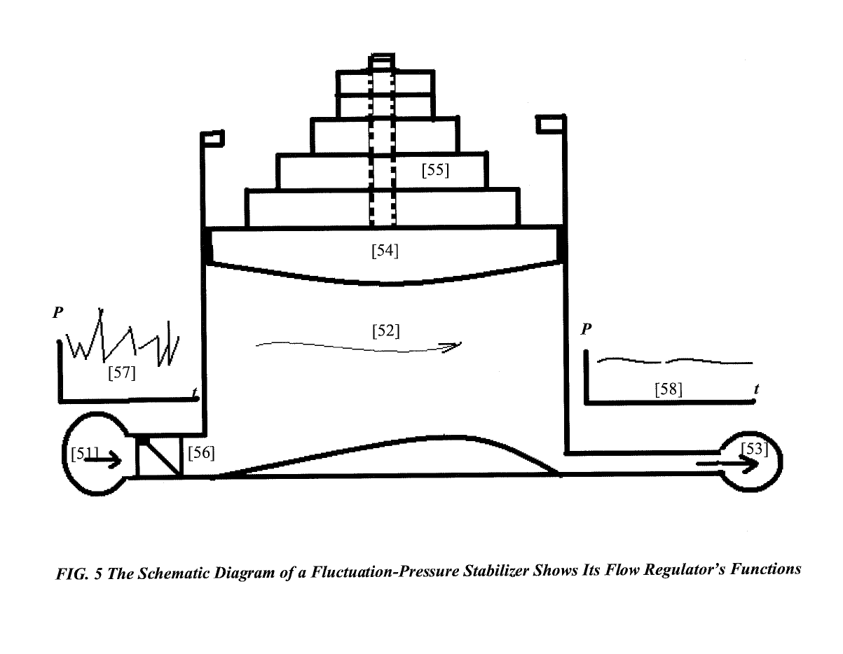

With reference now to FIG. 5, the present invention includes a main pump [51], a fluctuation-pressure pumping stabilizer [52], a power generation water-turbines [53]. The piston [54] adds suitable weight [55] to the fluctuation-pressure [57] pumping stabilizer [52], to which it moves up-down to balance the fluctuating pressure and to store the excess amount of flow for generating steady power, continuously. The check valve [56] prevents the pressurized flow from leaking back to the main pump [51]. The power generation water-turbines [53] have more stable pressurized [58] flow through to generate a steady rotational force (power) for the next stage device [a high-ratio gear reducer]. The scheme designed relations of adding the suitable mass [55] to regulate its flow from fluctuating states [57] to this one single steady state [58] are as the following:

Mass added: Pressure generated: Force generated: Power=Amperage×voltage generated

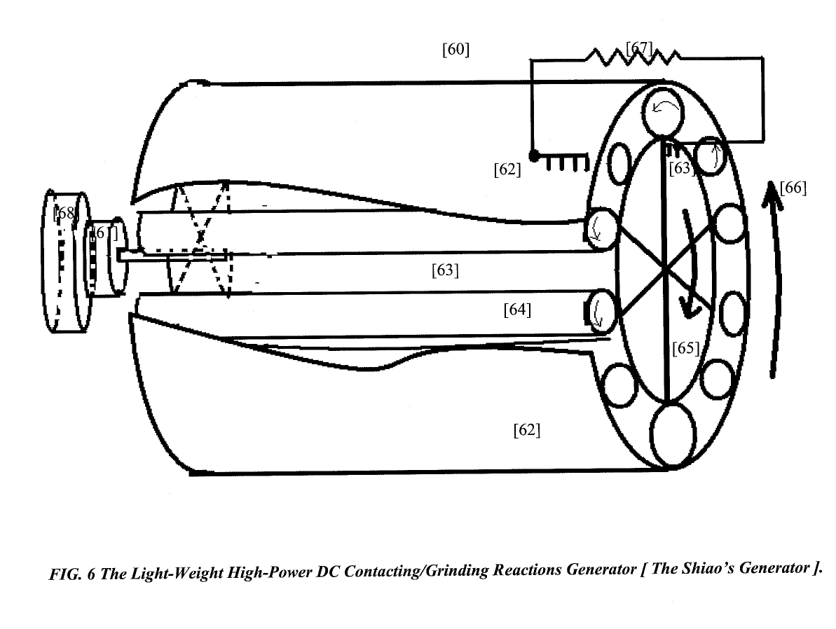

With reference now to FIG. 6, the present invention includes a light-weight generator [60]. This new power generator [60] is an improved design over a Van de Graff generator. The power generator uses the outer cylinder [62] and the inner cylinder [63] rotating in the opposite directions [65], [66], which motion will make the small rollers [64] between rotated. These contacting/grinding actions among the different material made cylinders/rollers generate the high-power DC electricity with its heavy loads [67], which has been referenced in our U.S. Ser. No. 11/472,517 filed on Jun. 12, 2006.

The high ratio gear reducer (1:1,000=1:10×10×10 in three stages) [61] increases speed to the generator [60]. Turbines are usually used at lower speeds. The high-ratio gear reducer [61] operates the generator [60] at a higher speed. A fluctuation-pressure stabilizer is attached to the water-turbines [68], which steady output allows the water-turbines [68] spin at a single steady speed and in a more continuous fashion. The light-weight generator [60] rotates at a single high speed of 5,000 rpm and more. In one embodiment of the invention, the wind turbines [21] have a variable fluctuating rotation speeds of between approximately 5 rpm (at 10 km/hr wind speed; blade's diameter is around 10 meters) and approximately 30 rpm (at 60 km/hr wind speed). But the fluctuation-pressure stabilizer [52] has a regulator's function, and its output to the water-turbines [53] has a single steady speed, continuously. The gear reducer [61] has a ratio of 1:1,000=1:10×10×10 in three stages. As long as the speed of the generator [60] is affected by the high efficiency lighter but stronger wind-turbines [21], a higher ratio gear reducer [61] can be used. These wind-turbines [21] generate high-efficiency work from the air stream. But there would be the lower efficiency for conventional methods of generating work from three solid propeller style turbines, which had much smaller reaction surface areas:

ΣP.ΔAₛₘₐₗₗ=P.[small blade area×fewer numbers of blades]=Fₛₘₐₗₗ. Our turbines [21] are attached to a main pump, a fluctuation-pressure stabilizer, a power generation water-turbines, and the gear reducer [61], which creates a high speed for the light-weight generator [60] to generate work. In FIG. 6, the more stable and slower-speed water-turbines [68] use a high ratio gear reducer [61] to increase its light-weight generator's [60] speed and meet its power requirement at 5,000 rpm and more.

As noted in U.S. Ser. No. 12/035,851, filed on Feb. 22, 2008, the working fluid absorbs heat from the ambient/non-ambient heat sources, and the liquid phase is evaporated into the high pressure saturated vapor. This higher pressure saturated vapor is used to generate power through two-phase turbines, whose blades are designed to be durable and balanced to rotate at a slow speed with better stability and less ball-bearing friction. These slow turbines are attached to a high ratio gear reducer to increase its generator's speed and meet its power generation requirements.

After the saturated vapor stream has gone through the turbines, work is extracted from this higher pressure stream. Because work has already been extracted out from this saturated vapor stream, this stream's pressure and temperature will be dropped and become into a condensed two-phase stream. Then, these partially condensed-phase streams flow into a phase separator. This cycle function (generating power at lower temperatures) without using the cooling condenser at a lower temperature is the best example and a new way for conserving these renewable power generations.

The foregoing descriptions of specific innovations of the present invention are presented for purposes of illustration and applications. They are not intended to be exhaustive or to limit the invention to the precise forms disclosed, and obviously many modifications and variations are possible in light of the above disclosure. It is intended that the scope of the invention is defined by the claims appended hereto and their equivalents. Therefore, the scope of the invention is to be limited only by the following claims.

Having thus described the invention, it is now claimed:

I/We claim:

1. A method for power generation using wind turbines, wherein the method utilizes down-wind wind turbines, a main pump, a fluctuation-pressure stabilizer, a power generation water-turbines, a high-ratio gear reducer, and a contacting/grinding reaction generator, wherein the method comprises the steps of:
generating a pressure difference of air current stream from solar energy;
extracting practical work from the current stream via the wind turbines;
stabilizing the fluctuation-pressure inputs into a single steady state hydraulic flow, continuously via a fluctuation-pressure stabilizer;
increasing the associated generator's speed via the associated high-ratio gear reducer; and,
generating high-power DC electricity through the associated contacting/grinding reaction generator, wherein after extracting wind power, the air current loses its ambient dynamic energy.

2. The method of claim 1, wherein the wind turbines power generator further comprises:
a light-weight power generator, the power generator operatively connected to a mounting member on the ground;
two oppositely rotating cylinders, the cylinders being made of different materials;
intermediate rotating rollers between the oppositely rotating cylinders; and,
rotating shafts, wherein the cylinders, rollers, and shafts are operatively connected to the light-weight power generator on the ground, wherein the wind turbines have multiple blades, wherein the blades have a single surface made of a light-weight nylon fabric, wherein the blades have an angle strut support structure behind.

3. The method of claim 1, wherein the turbines comprise slow-speed turbine blades with more than four blades, wherein each blade has a stream-line leading edge of support structure, a tailing edge, a top, and a bottom, wherein the blades, between the support structure edges, has a parabolic stream-line single-surfaced blade layer, and the edges extend beyond the frame structure of the bottom.

4. The method of claim 1, wherein a single rate is designed for the steady-speed water-turbines, from which it connects to a high ratio gear reducer to increase speed to the generator and meet the generator's power generation requirements at 5,000 rpm and more.

5. The method of claim 3, wherein the method further comprises the step of:
automatically adjusting the pitch of the blade by its uneven strong wind pressure generated at the blade's rear parts if the wind speed exceeds approximately 50 miles/hr, or 80 km/hr.

6. A low-temperature heat engine device comprising:
at least one down-wind two-phase turbine mounted on the top of the mounting pole;
at least one main hydraulic pump mounted on the ground;
at least one fluctuation-pressure stabilizer mounted on the ground;
at least one power generation water-turbines mounted on the ground;
at least one high ratio gear reducer mounted on the ground; and,
at least one contacting/grinding reaction generator mounted on the ground, wherein the device has an air cooled device.

7. The device of claim 6, wherein the two-phase turbines blades have a rotation scheme designed speed: vₐᵢᵣ=2π.R [rpm/60 sec]=v_{blade's tip}; v_{blade's tip}=vₐᵢᵣ, for maximizing the power production, and the device further comprises:
a hydraulic system capable of automatically adjusting the pitch of a turbine blade from its rear parts.

8. The device of claim 7, wherein each blade has a stream line support structure leading edge, a tailing edge, a top, and a bottom, wherein the blade support structure of an angle strut, between the edges, supports a parabolic single-surfaced nylon fabric blade layer, and the edges extend beyond the bottom.

9. The device of claim 6, wherein the turbines are two-phase turbines, and wherein a main hydraulic pump mounted on the ground is connected to the two-phase turbines by rotation shafts.

10. The device of claim 6, wherein a pump, a fluctuation-pressure stabilizer, a power generation water-turbines, and a high ratio gear reducer are operatively connected between the turbines and a ground-mounted generator to increase speed of the ground-mounted generator at greater than about 5,000 rpm.

11. The device of claim 6, wherein a light-weight power generator is operatively connected to a mounting member on the ground, in which there are oppositely rotating cylinders, rotational rollers, and rotational shafts, wherein the cylinders, rollers, and shafts are operatively connected to the power generator.

12. A wind turbines system comprising:
a pole mounting member;
a light-weight power generator, the power generator operatively connected to a ground mounting member;
oppositely rotating cylinders, rotational rollers, and rotational shafts, wherein the cylinders, rollers, and shafts are operatively connected to the power generator;
back supported structure with rotation rollers; and,
multiple blades, the blades being operatively connected to the rotational shaft, wherein the blades have a light-weight, nylon fabric, single-surfaced blade layer, and a angle strut support frame structure.

13. The turbines system of claim 12, wherein the system further comprises:
at least one pump mounted on the ground connected to the wind turbines by rotation shafts;
at least one fluctuation-pressure stabilizer mounted on the ground;
at least one power generation water-turbines mounted on the ground; and,
at least one high ratio gear reducer mounted on the ground; and,
wherein the power generator is at least one contacting/grinding reaction generator mounted on the ground, wherein the generator has an air cooled device.

14. The device of claim 12, wherein turbines are two-phase turbines, and the two-phase turbines have fluctuating rotation speeds of between approximately 5 rpm to approximately 30 rpm, and the turbines further comprise:
an automatic hydraulic system capable of adjusting the pitches of the blades from the rear parts as their safety devices.

15. The device of claim 13, wherein the ground-mounted gear reducer has a ratio of approximately 1:1,000=1:10×10×10 in three stages, and the ground-mounted generator has a single rotation speed of at least approximately 5,000 rpm.
